(19) United States
(12) Patent Application Publication
(10) Pub. No.: US 2026/0225288 A1
(43) Pub. Date: Aug. 6, 2026

(54) 3D PRINTING AND FABRICATION

(71) Applicant: KING ABDULLAH UNIVERSITY OF SCIENCE AND TECHNOLOGY, Thuwal (SA)

(72) Inventors: Hamed ALBALAWI, Thuwal (SA); Panagiotis BILALIS, Thuwal (SA); Charlotte A.E. HAUSER, Thuwal (SA)

(21) Appl. No.: 19/547,973

(22) Filed: Feb. 24, 2026

Related U.S. Application Data
(62) Division of application No. 18/210,684, filed on Jun. 16, 2023, now abandoned.
(60) Provisional application No. 63/353,937, filed on Jun. 21, 2022.

(51) Int. Cl. B29C 33/38; B29C 64/118; B29C 71/04; B29K 67/00; B29L 31/00; B33Y 10/00; B33Y 30/00; B33Y 80/00

(52) U.S. Cl. CPC B29C 33/3892; B29C 64/118; B29C 71/04; B33Y 10/00; B33Y 30/00; B33Y 80/00; B29K 2067/046; B29L 2031/00

(57) ABSTRACT

A modified approach for coral restoration by merging 3D printing and molding techniques is presented. This is achieved by 3D scanning live coral specimens, retrieved from sea dives, to obtain a CAD model of the complete coral 3D construction with complex geometries. Select areas of the model are flattened to create a 2D base for micro-fragment adhesion. From the CAD models, disclosed embodiments propose two methods of fabrication. Method A consists of 3D printing the CAD models with commercial thermoplastic materials to create a negative mold, subsequently loaded with synthesized Calcium Carbonate Photoinitiated (CCP) ink to form an eco-friendly coral skeleton. Method B uses syringe-based extrusion 3D printing to directly print a coral skeleton with CCP ink. Both methods are evaluated as a combined proof-of-concept process, 3D CoraPrint, for coral gardening and restoration and providing details required for mimicking coral and bone 3D structures for implantation in bone grafting applications.

### CROSS-REFERENCE TO RELATED APPLICATIONS

This application claims priority to U.S. application Ser. No. 18/210,684, entitled “3D PRINTING AND FEBRICATION”, filed Jun. 16, 2023, which claims the benefit of priority of U.S. Provisional Application No. 63/353,937, entitled “PRINTABLE CALCIUM CARBONATE PASTE FOR SURGICAL AND ENVIRONMENTAL APPLICATIONS,” filed Jun. 21, 2022, and refers to “SUSTAINABLE AND ECO-FRIENDLY CORAL RESTORATION THROUGH 3D PRINTING AND FABRICATION,” in ACS Sustainable Chemistry & Engineering journal published on Sep. 2, 2021. The entire contents and disclosures of this patent application are incorporated herein by reference in their entirety.

This application refers to U.S. Provisional Patent Application No. 63/353,906, entitled, “NATURAL-BASED INK FOR BIORECONSTRUCTION OF LIVING SYSTEMS,” filed Jun. 21, 2022, and to “ECOLOGICALLY FRIENDLY BIOFUNCTIONAL INK FOR RECONSTRUCTION OF RIGID LIVING SYSTEMS UNDER WET CONDITIONS,” in International Journal of Bioprinting journal published on Aug. 19, 2021. The entire content and disclosure of this patent application and publication is incorporated herein by reference in their entirety.

### BACKGROUND

### Field of the Invention

The present disclosure relates generally to 3D printing and fabrication and, more specifically, to 3D printing and fabrication techniques in applications for coral restoration and bone grafting.

### Background of the Invention

Coral reef degradation is a widespread rising problem, driven by marine heat waves, the spread of diseases and human impacts by overfishing and pollution. Despite dozens of coral restoration projects, the approaches still face several challenges, and are typically small in scale, while being expensive yet ineffective. This highlights the worldwide priority of finding novel alternatives for the restoration of coral reefs. Further, a need exists for providing intricate details required for mimicking coral and bone 3D structures.

### SUMMARY

According to first broad aspect, the present disclosure provides an apparatus for a subject comprising: a fabrication of a digital scan of the subject and having a seeded micro-fragment of a clonal organism attached thereto.

According to a second broad aspect, the present disclosure provides a method of manufacturing a scaffold for a subject comprising: scanning the subject to form a digital model of the subject; modifying a digital geometry of the digital model to form a modified digital model; fabricating the modified digital model to form a scaffold; and seeding a micro-fragment of the subject to the scaffold.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

The patent or application file contains at least one drawing executed in color. Copies of this patent or patent application publication with color drawing(s) will be provided by the office upon request and payment of the necessary fee.

FIGS. 1A-1D illustrates diagrammatic drawing of standard 3D printers according to one embodiment of the present disclosure.

FIG. 2 illustrates conceptual model showing 3D CoraPrint, the scalability of the proposed fabrication Methods A and B for coral restoration according to one embodiment of the present disclosure.

FIG. 3 illustrates schematic diagram showing 3D CoraPrint's fabrication methods.

FIGS. 4A-4B illustrates 3D coral replicas fabricated using Method A (top) and Method B (bottom) with design adjustments for micro-fragment attachment and adhesion according to one embodiment of the present disclosure.

FIG. 5 illustrates assessing toxicity of polyactic acid (PLA) corals according to one embodiment of the present disclosure.

FIG. 6 illustrates assessing toxicity of calcium carbonate photoinitiated (CCP) corals according to one embodiment of the present disclosure.

FIG. 7 illustrates a device for applying a 3D printing method according to one embodiment of the present disclosure.

FIG. 8 illustrates a schematic view of the Liquid Crystal Display (LCD) 3D printing process, according to one embodiment of the present disclosure.

FIG. 9A illustrates SEM images of calcium carbonate according to one embodiment of the present disclosure.

FIG. 9B illustrates SEM images of calcium carbonate photoinitiated (CCP) according to one embodiment of the present disclosure.

FIG. 10 illustrates Acropora Tricolor and Fungiidae 3D printed structures seeded with coral fragments, according to one embodiment of the present disclosure.

FIG. 11A illustrates a 3D printed scaffold with a calcium carbonate photoinitiated (CCP) material, according to one embodiment of the present disclosure.

FIG. 11B illustrates a 3D print of a 3D printing test model, according to one embodiment of the present disclosure.

FIG. 12A illustrates a live/dead cell viability assay of human dermal fibroblast (hDF) on 3D printed CCP and CPP 24 hours post seeding, according to one embodiment of the present disclosure.

FIG. 12B illustrates cell viability in 3D CCP and CPP for one day post seeding, according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

Unless defined otherwise, all technical and scientific terms used herein have the same meaning as is commonly understood to which the claimed subject matter belongs. In the event that there is a plurality of definitions for terms herein, those in this section prevail. All patents, patent applications, publications and published nucleotide and amino acid sequences (e.g., sequences available in GenBank or other databases) referred to herein are incorporated by reference. Where reference is made to a URL or other such identifier or address, it is understood that such identifiers can change and particular information on the internet can come and go, but equivalent information can be found by searching the internet. Reference thereto evidences the availability and public dissemination of such information.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, the term “cell-laden tissue scaffold” refers to the addition of cells on a 3D printed scaffold to form a tissue.

For purposes of the present disclosure, the term “extrusion-based 3D printing” refers to Fused Deposition Modeling (FDM). It is a 3D printing process that uses spools of plastic or metal filament that extrudes through a temperature-controlled nozzle layer by layer to create a 3D part.

For purposes of the present disclosure, the term “hydroxyapatite” refers to naturally occurring mineral form of calcium apatite. Hydroxyapatite is the hydroxyl end member of the complex apatite group. The OH ion can be replaced by fluoride, chloride, or carbonate.

For purposes of the present disclosure, the term “light,” unless specified otherwise, refers to any type of electromagnetic radiation. Although, in the embodiments described below, the light that is incident on the gratings or sensors is visible light, the light that is incident on the gratings or sensors of the present disclosure may be any type of electromagnetic radiation, including infrared light, ultraviolet light, etc., that may be scattered by a grating or sensor. Although, in the embodiments described below, the light that is scattered from the gratings or sensors and detected by a detector is visible light, the light that is scattered by a grating or sensor of the present disclosure and detected by a detector of the present disclosure may be any type of electromagnetic radiation, including infrared light, ultraviolet light, etc. that may be scattered by a grating or sensor.

For purposes of the present disclosure, the term “photoinitiator” refers to a molecule that creates reactive species such as free radicals, cations or anions when exposed to radiation such as UV or visible sources such as blue light, for example.

For purposes of the present disclosure, the term “polyether” refers to any of a class of organic substances prepared by joining together or polymerizing many molecules of simpler compounds such as monomers by establishing ether links between them, which may be either chainlike or network like in molecular structure.

For purposes of the present disclosure, the term “scaffold” refers to a 3D printing structure to host coral fragments for coral restoration or cells for a bone grafting application.

For purposes of the present disclosure, the term “seeding” refers to a method to attach live coral fragments for coral restoration applications or a method to add cells on a scaffold to produce surfaces, for example, for bone grafting applications.

For purposes of the present disclosure, the term “subject” refers to an entity which is the object of treatment, observation, or experiment. By way of example only, a “subject” may be, but is not limited to: a human, a mammal, a reptile, a bird, a fish, an amphibian, and an invertebrate.

For purposes of the present disclosure, the term “thermoplastic filament” refers to a thermoplastic, or a polymer, that melts when heated and is extruded through a nozzle layer by layer to create a three-dimensional object. After the filament is extruded, it cools and becomes the surface the next layer is deposited on top of.

For purposes of the present disclosure, the term “3D printing” refers to the action or process of making a physical object from a three-dimensional digital model which may typically include laying down many thin layers of a material in succession. In some embodiments, 3D printing, or additive manufacturing is the construction of a three-dimensional object such as from a CAD model or a digital 3D model that is converted into a G-code that provides the pathway to define the printed structure. It can be done in a variety of processes in which material is deposited, joined, or solidified under computer control, with the material being superposed layer-by-layer and added together (such as termo-plastics, viscous-liquids or compressed-powder grains being fused), typically layer by layer.

### DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

Coral reef degradation is a widespread rising problem, driven by marine heat waves, the spread of diseases and human impacts by overfishing and pollution. The capacity to restore coral reefs, in order to reverse realized losses, lags behind our capacity to restore other marine ecosystems in scale, effectiveness and cost efficiency. The common approach, involving the formation of the carbonate skeleton is a rate-limiting step in the growth of scleractinian corals, which requires coral restoration technologies to provide a structural frame to support coral growth. Such approaches are evolving from the use of bulky concrete blocks and metal frames to more sophisticated efforts that reverse engineer harvested corals to produce artificial coral skeletons of similar geometries, which can facilitate coral restoration and gardening. The process of 3D printing is currently gaining increased attention for coral restoration due to the ease of creating designs at an increased level of accuracy and the convenience of rapid prototyping. An important factor to consider in the reverse engineering process is the type of 3D printing technology to be used to print coral skeletons. This largely depends on the material composition and the printing requirements. Extrusion-based printing is most popular due to its low-cost, relative efficiency, and suitability for a wide range of biomaterials as compared to other printing methods. Herein, disclosed embodiments suggest a modified approach for coral restoration by merging 3D printing and molding techniques. This is achieved by 3D scanning live coral specimens, retrieved from sea dives, to obtain a CAD model of the complete coral 3D construction with its complex geometries. Select areas of the model are flattened to create a 2D base for micro-fragment adhesion. From the CAD models, disclosed embodiments propose two methods of fabrication. Method A consists of 3D printing the CAD models with commercial thermoplastic materials to create a negative mold, which is subsequently loaded with synthesized Calcium Carbonate Photoinitiated (CCP) ink to form an eco-friendly coral skeleton. Method B uses syringe-based extrusion 3D printing to directly print a coral skeleton with CCP ink. Both of these methods are evaluated as a combined proof-of-concept process, 3D CoraPrint, for coral gardening and restoration. While the disclosed 3D scanning discusses applications for live coral specimens, it is readily appreciated that disclosed embodiments provide other 3D scanning techniques that may be applied, for example, to other subjects including, but not limited to: a human, a mammal, a reptile, a bird, a fish, an amphibian, and an invertebrate.

In one embodiment, corals are clonal organisms made up of extensive amounts of polyps that are able to spread relatively rapidly in 2D structure. 3D growth is achieved, in scleractinian corals, by the development of a calcium carbonate skeleton that provides the complex 3D structure characteristic of coral structures.¹ This renders scleractinian corals to be engineering species that alter the environment in which they grow and provide a structurally-complex habitat that underpins the vast biodiversity they support. However, the development of the carbonate skeleton is a slow process, resulting in vertical extension rates in the order of millimeters per year. In this way, the slow precipitation of carbonate to form the coral's skeleton is considered among the most significant rate-limiting steps in coral reef formation.² The coral cover protects the carbonate skeleton from dissolving and weakening when coming into contact with water, however the ongoing and future ocean acidification reduces corals survival.³ Coral bleaching, which entails the rupture of the relationship between corals and the photosynthetic Symbiodiniaceae symbiont, often leads to coral mortality and the exposure of the carbonate skeleton, and eventually skeletal erosion. The projected loss of coral reefs requires raising the ambition to conserve and restore these biological systems.⁴ Despite dozens of coral restoration projects, the approaches still face several challenges,^{2,5-7} and are typically small in scale, while being expensive yet ineffective. This highlights the worldwide priority of finding novel alternatives for the restoration of coral reefs.⁸ The UN Decade on Ecosystem Restoration (2021-2030) aims to enhance the role of restoration as a path to rebuild blue natural capital,^{4,9} along with the development of a Coral Reef R&D Acceleration Platform to advance our capacity to restore coral reefs at scale.¹⁰

Current restoration methods center on coral outplanting, which often applies the nursery approach for propagation of corals, enabling enhanced survivorship, growth and coral attachment.^{11,12} This technique aims to facilitate the propagation of corals typically by means of asexual propagation.⁸ Other techniques assist coral restoration by providing suitable complex 3D supports for coral growth and recruitment.¹³ Supports can be created by the production of metal structures, applying electrical fields with the aim of catalyzing carbonate deposition, and also by deploying cement structures, such as domes and others, enabling coral attachment and settlement.^{13,14} Recently, the advent of 3D printing offers an alternative solution to manufacture complex 3D objects, opening a new avenue to create artificial coral structures.

The process of 3D printing has several advantages over traditional fabrication methods due to its convenience for rapid prototyping, ease of customization, and potential for scalability.¹⁵ 3D printing technology has improved tremendously over the past few decades, thus allowing printability at higher resolutions and accommodating a wider range of fabrication materials. These factors make 3D printing a promising fabrication method for coral restoration.¹⁶ As coral species vary in size, shape, and structure, the design and fabrication process requires rapid customization and agility to be easily applicable to a wide range of complex geometries. The ability to maintain repeatability and accuracy of 3D printed objects is also a key element for scalability of coral fabrication. Moreover, it has been reported that 3D printed coral-like structures not only enhance larvae settlement by the development of more natural-like surfaces, but also enable the seeding of microorganisms within the printing material for bioprinting.^{17,18} In the future, this technology could be further exploited to incorporate molecules for enhancing larvae settlement and inhibiting undesired algal growth within the printed coral. However, as the 3D printing technology progresses, it is important to consider the current advantages and limitations of this technology for coral reef restoration.

An extensive variety of materials has been used for 3D printing to-date. This includes the use of stainless steel, ceramics, iron, plastics and polymers, among many other types of synthetic materials.¹⁹ Similarly, the printing of coral-like structures has been mainly performed with synthetic- or natural-based materials. These materials include: resins, sandstone, cement, geopolymers, ceramic clay, powder and ABS plastic filaments.^{16,20-24} The effect of using synthetic-based structures for coral restoration has not been extensively studied and could potentially jeopardize the environment by the release of toxic compounds.²⁵ On the other hand, recently the 3D printing of corals with PLA (polylactic acid)-based filaments did not show any signs of deterioration to brooding coral or coral reef fish.¹⁸ However, few studies report the use of ecologically friendly materials like polylactic acid (PLA) based biodegradable bioplastics.^{18,26} Therefore, there's currently a growing need for the introduction of other environmentally friendly printable materials that can also be used as alternative material for the restoration of coral structures.

Disclosed embodiments provide an extensive overview of the current efforts, materials and approaches available in 3D printing and their applicability to coral restoration. Disclosed embodiments also identify current limitations of the process as well as future developments needed to push the limits of this technology to secure a future for coral reefs. Disclosed embodiments assess the practicality of 3D printing corals as an alternative method to traditional coral nurseries and compare feasibility in terms of time, cost, and scalability. Disclosed embodiments then present a conceptual model for a 3D printing facility designed for coral fabrication as a component of large-scale coral restoration technologies. Lastly, disclosed embodiments introduce a new, more eco-friendly approach for the 3D printing of coral structures and present preliminary results obtained with this method.

### Fundamentals of 3D Printing

In one embodiment, three-dimensional (3D) printing is a prototyping technique, often referred to as additive manufacturing technology, that enables the formation of physical 3D objects via layer-by-layer extrusion of the fused materials. Based on the intended use of the printed objects, materials and printing methods can vary.¹⁶ Different materials can be utilized, such as plastic, liquids, powders, ceramics, living cells, etc. Moreover, there are various popular technologies used today in 3D printers (Table 1), such as Fused Deposition Modeling (FDM) and Stereolithography Apparatus (SLA).²⁷ FDM technology is the most widely used, often in producing small parts of minimal complexity. On the other hand, SLA has often been used to produce complex parts with support structures, providing a smooth finish to the final printed parts. Other technologies have also been implemented in 3D printing to meet field-specific requirements (Table 1). However, the printing of coral skeletons requires high shape complexity, which poses a challenge to conventional printing techniques.²⁸

### Fused Deposition Modeling (FDM)

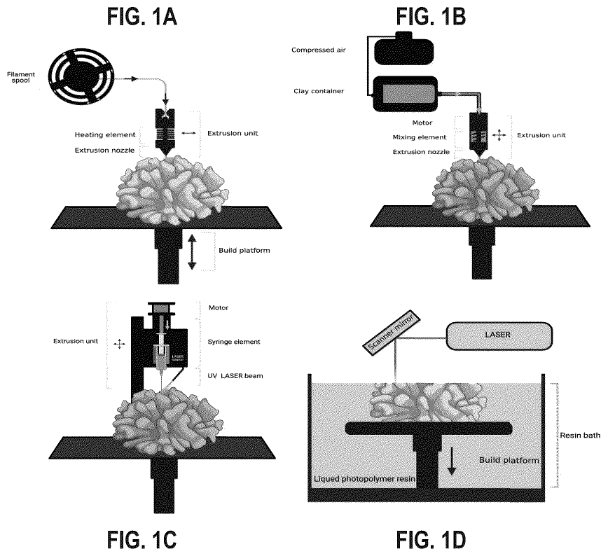

FDM is an additive prototyping process that uses an extrusion unit to dispense materials in a layer-by-layer fashion to create 3D printed objects (FIGS. 1A-1B).

FIG. 1A illustrates a standard FDM 3D printer using a thermoplastic filament as printing material along with other required components such as heating element and extrusion nozzle. The build platform, or print bed, moves in the z-axis, and the extrusion unit moves in the x-y coordinates. Traditional FDM printers (FIG. 1A) usually use thermoplastic materials with the help of a mechanical feeder to push the filament toward a heated component, resulting in softened materials at the time of dispensing. However, recent experiments with FDM have also used clay-based materials to print 3D objects,^{29,30} although some materials require a heating platform to deposit the first layer of the print correctly. Depending on the complexity of the final object, different filaments and nozzle diameters can be utilized to achieve the best printing resolution. The extrusion unit can also vary according to the nature of the material. For instance, printing with clay does not require a heating unit, rather, a mixing unit is used to ensure homogeneous material at the extrusion point (FIG. 1B). FIG. 1B illustrates a standard clay printer using compressed air to push clay toward a mixing element and extrusion nozzle. The extrusion unit moves in a three-axis direction. Such modifications can be applied to FDM printers for use of other materials of similar textures and viscosities, in order to achieve the specific extrusion requirements necessary for the material to be considered printable, which in turn enables the application of FDM for various coral printing applications.

The FDM process can be applied to print a wide range of viscous materials. These materials can be printed using syringes mounted on nozzle tips of different diameters. Syringe-based FDM printing has been widely used in tissue engineering and regenerative medicine.³¹ This approach allows printing of living cells, enabling this method to be commonly used in 3D tissue printing.³² Extensive research has been done in the laboratory using syringe-based FDM 3D printers for fabrication of cell-laden tissue scaffolds. The experience gained has provided valuable insight in using similar approaches for environmental conservation efforts, including coral restoration.^{33,34} Some viscous materials require a curing process for material solidification, which is a practical option for coral printing. These materials are more manageable during extrusion, yet result in solid structures post-curing, and composed of hybrid materials such as inorganic compounds mixed with photopolymer resin. Calcium carbonate, specifically aragonite, is the basis of coral skeletons. Hence, a process of syringe-based FDM printing with calcium carbonate hybrid materials could enable the printing of more complex and eco-friendly coral structures for reef restoration applications (FIG. 1C). FIG. 1C illustrates diagrammatic drawing of syringe extrusion-based 3D printer uses particular photoinitiated ink and an extrusion unit capable of moving in the x-y-z coordinates. LASER beam is mounted on the extrusion unit to help solidify the ink after the extrusion point.

### Stereolithography (SLA)

Stereolithography uses a laser source to selectively photopolymerize liquid photopolymer materials to produce solid objects.^{16,32} SLA is considered to be an additive manufacturing technology, as the structures are created in a layer-by-layer process. SLA uses an ultraviolet (UV) laser to scan a 2D cross-sectional area of a 3D object which cures the resin of the 2D section. An elevator (FIG. 1D) lowers the platform to allow the process to be repeated over the first layer of the cured photopolymer resin.³⁵ FIG. 1D illustrates diagrammatic drawing of a standard SLA 3D printer uses LASER and scanner mirror to project and solidify the liquid photopolymer resin. The build platform moves in the z-axis. In SLA, the build platform plays a major role in creating the 3D object (FIG. 1D), since the active movement of lowering the platform is required after each layer. This allows the liquid resin to accumulate in a thin area between the platform and the laser beam. Then, the printer selectively hardens the resin against the platform. This process is then repeated to create the 3D object.¹⁶ 3D Printing with the SLA method has been applied in printing of artificial muscle and acellular tissue scaffolds.^{36,37} Moreover, SLA is compatible with several types of materials like Polycaprolactone (PCL), gelatin methacrylate (GelMa), resins and functionally-graded materials for the printing of 3D structures.^{36,38} Recently, this technology has been used for bioprinting.³⁹ However, the downside of this technology is its high cost which could affect the overall economic feasibility of its use.⁴⁰

In 2015, SLA led to a newer, faster, more accurate technology called Continuous Liquid Interface Production (CLIP).^{35,41} CLIP no longer needs to raise the plate to allow a fresh layer of resin to accumulate in order to solidify the next layer. CLIP simply uses an oxygen-containing dead zone, which allows a thin layer of uncured resin to flow between the light source and the cured 3D object attached to the build platform.^{16,41} This is a game-changer technology where the time spent on an object using traditional additive manufacturing can be reduced by 50%. Moreover, the improved resolution and the range of materials used in CLIP technology can improve printing quality, leading CLIP to be one of the most promising technologies in 3D printing technology.⁴¹ Therefore, this technology offers high expectations to be used for the printing of complex coral structures. However, as with any new technology, it needs more time to become cost-efficient and commercially available.

TABLE 1
Summary of the leading 3D printing technologies

| 3D | | Compatibility | | | | |
|---|---|---|---|---|---|---|
| printing | | with calcium | | | | |
| technology | Materials | carbonate | Speed | Scalability | Considerations | References |
| FDM | Plastic filaments | Compatible, | Average | Less expensive | Prints have a | ^{40, 42-48} |
| | (mainly | commercially | | than SLA and | well-defined | |
| | PLA and | available | | conventional 3D | architecture | |
| | ABS) | limestone | | printing, slow for | and geometry. | |
| | Clay | filament | | the fabrication of | Not suitable for | |
| | | | | large amounts of | the printing of | |
| | | | | structures | objects with | |
| | | | | | diameter or | |
| | | | | | size lesser than | |
| | | | | | 0.2 cm | |
| SLA | Resins, | Compatible | Slow | Limited | Compatible | ^{16, 40, 42, 49} |
| | liquid | with calcium | | throughput, very | with | |
| | photopolymers | carbonate-based | | time-consuming | conventional | |
| | | material | | for the printing of | 3D printing | |
| | | | | large amounts of | materials and | |
| | | | | structures | biomaterials. | |
| | | | | | High precision | |
| | | | | | and accuracy. | |
| | | | | | Requires post- | |
| | | | | | processing, | |
| | | | | | potential | |
| | | | | | toxicity | |
| CLIP | Liquid | Has not been | Very fast | Enables rapid | High | ^{40, 50, 51} |
| | photopolymers | evaluated | | printing speed | resolution | |
| | | | | and improved | prints. Time | |
| | | | | resolution | consuming for | |
| | | | | | the printing of | |
| | | | | | structures with | |
| | | | | | large cross- | |
| | | | | | sectional areas | |

3D printing corals: progress to-date

The printing of 3D corals for reef restoration has gained relevance in recent years, and several approaches aim to set the basis for enhancing coral printing. Recent research includes the printing of scleractinian coral skeletons with Colorfabb co-polyester (nGen, XT), PLA-PHA and Proto-Pasta PLA-based filaments as an exploratory study for coral reef behavioral research and the printing of 1 m coral-shaped structures for reef restoration.^{18,26} Other studies incorporate the printing of coral specimens at their natural size by the tangible props method with epoxy and plaster using Inkjet-based printing.^{16,52} Conventional approaches include materials like sand, plaster, plastic filaments, cement and basalt fiber.^{53,21} Similarly, cement, sandstone and PLA have been used for the 3D printing of coral skeletons from Turbinaria and Oulophyllia species. The construction of coral units with the powder bed fusion method has been achieved using sandstone powder, and by Inkjet-based printing with ceramic clay.^{20, 24, 25, 54} Moreover, the printing of several coral species by FDM, SLA, Laminated Object Manufacturing (LOM) and binder jetting have been reported.²¹ To-date, most attempts at 3D printing coral structures used synthetic materials with some reporting printing with plastic-based filaments.²⁴

Novel approaches for coral printing aim to revolutionize conventional coral printing while also mimicking natural properties of corals, such as the development of printed coral polyp structures.¹⁷ Other approaches aim to develop hybrid materials for coral printing and achieve printing of 3D bionic corals with biologically-active microorganisms.^{20,55} More recently, robotic-assisted 3D printing of corals with ceramic material has been introduced.⁵⁶ These approaches present a step forward in the development of forefront alternatives to conventional coral printing. A summary of the main 3D printing projects for coral restoration is provided (Table 2).

TABLE 2
The 3D printing of coral structures

| Project | Approach | Year | Reference |
|---|---|---|---|
| Bionic corals | 3D printing of coral | 2020 | ¹⁷ |
| | structures with | | |
| | microorganisms | | |
| Printed coral platforms | 3D robotic assisted printing | 2020 | ¹³ |
| | of structural platforms for | | |
| | corals | | |
| Artificial corals | 3D-printed corals | 2018 | ²¹ |
| Plastic corals | 3D printed corals with PLA | 2018 | ⁵⁴ |
| | and ABS | | |
| Modular Artificial Reef | Open hexagonal spider-like | 2013 | ^{56, 57} |
| Structure | steel structures coated with | | |
| | resin and coarse sand | | |
| Sustainable Oceans | 3D printing of 1 m coral- | 2012 | ¹⁸ |
| International | shaped structures | | |

### Pushing the Boundaries of 3D Printing in Support of 21st Century Coral Reef Restoration

3D printing technology presents a valuable addition to coral restoration.^{21,54} However, current limitations to this technology include scalability, feasibility and environmental impact within the marine habitat.⁵⁸ Bringing 3D printing from an exercise in production of coral-like objects to a technology that can support coral reef restoration on a broader scale requires assembling interdisciplinary teams, including expertise in marine biology and ecology, engineering, biotechnology, material sciences, chemistry and computational sciences. The development of such interdisciplinary teams is fundamental in supporting the evolution of novel alternatives for coral printing, by addressing areas such as the incorporation of interspecific hybridization, tetrapod seeding, the construction and analysis of underwater coral structures, coral bioprinting and 3D printing.^{17,59-62} Moreover, scaling of 3D printing technologies for coral 3D-printing requires the integration of faster printers with increased working capacities and development of ecologically-friendly materials for printing. Realizing the implementation of 3D printing for large-scale restoration of coral reefs requires that current limitations be solved.

### 3D CoraPrint: A New 3D Printing Method to Support Coral Reef Restoration Programs

Disclosed embodiments recently outlined a new approach to coral reef restoration, involving land-based nurseries to produce selected coral reefs at scale⁸. Achieving effective coral reef restoration at scale requires a suite of techniques, which, disclosed embodiments propose, shall include 3D printing approaches, once these are rendered feasible and cost-effective at scale.

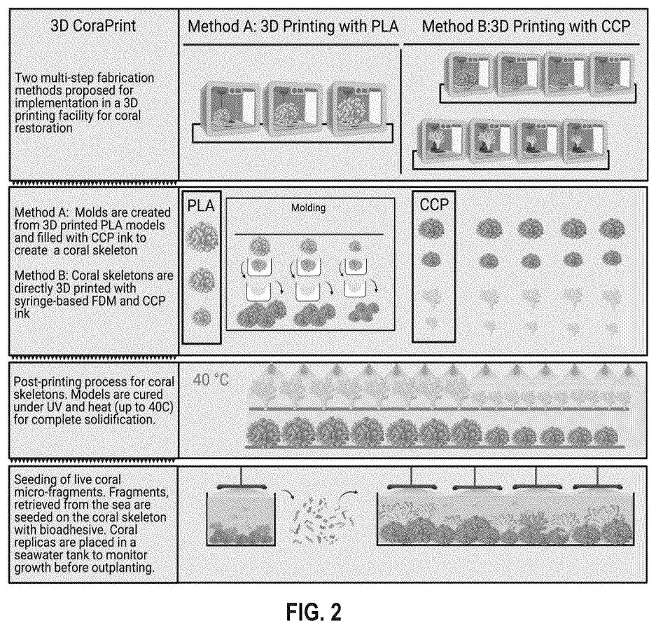

For coral restoration, disclosed embodiments developed 3D CoraPrint, consisting of two multi-step 3D fabrication methods to replicate geometries of live corals and fabricate eco-friendly models (FIG. 2). Method A involves the scanning of live corals, modification of 3D geometries, 3D printing of a coral skeleton with commercial PLA and creating a silicone mold for our in-house developed Calcium Carbonate Photoinitiated ink (CCP). Method B consists of scanning live corals, modification of 3D geometries, and direct 3D printing of a coral skeleton with CCP.

All previous methods for 3D printed corals produced an inert structure, but no explicit strategy has been proposed on how to turn this artificial skeleton into a living coral. The assumption is that this would be achieved through the passive colonization by larval coral polyps once the structure has been submerged in the receiving location. This passive approach involves, however, uncertainties, as many benthic organisms compete for settlement space, so the settled organisms may differ from those targeted, and because coral larvae are known to have specific settlement requirements, often associated to the presence of coralline algae.^{63,64} We, therefore, devised our CoraPrint technology to include a method to attach 2D micro-fragments of live coral to the 3D printed skeleton, thereby initiating their colonization by the desired, pre-adapted coral colony (FIG. 2).

The 3D printing of eco-friendly skeletons and seeding of live coral fragments would expedite the growth process as compared to growing corals to full-size from micro-fragments. Using our proposed methods, disclosed embodiments envision implementation in a 3D printing facility designed for restoration of multi-hectare scale coral reefs. Disclosed embodiments propose 3D printing as a complementary method for the fabrication of slow-growing corals to be embedded in restoration projects, thereby increasing the diversity of corals in the restored community.

### Designing a 3D Printing Facility for Coral Reef Restoration

A 3D printing facility for coral reef restoration requires access to several fabrication technologies. As a conservative estimate, a basic facility would need to house a 3D scanner (e.g., $20,000 all estimates of costs are in 2021 prices), 2 high-end conventional FDM/SLA 3D printers (e.g., $5,000 ea.), 2 UV curing basin (e.g., $700 ea.), and 10 high-end screw-driven or pressure-driven 3D printers suitable for viscous inks (e.g., $20,000 ea.), and several computer stations with modeling, CAD, and printing software (e.g., $20,000 ea.). For a total of approximately $300,000 in capital investment, a fully functional 3D printing facility would provide capabilities for fabrication of coral skeletons and replicas of sizes up to 20 cm. This matches the recommended size of coral transplant units for coral reef restoration projects.⁶⁵ Extending this facility to allow printing of coral skeletons with characteristic sizes of up to 100 cm will require a capital investment of approximately, for example, $400,000 in 2021. Disclosed embodiments note, however, that the cost of 3D printers and associated hardware is declining rapidly at almost 50% per year.⁶⁶ So a facility allowing printing of 100 cm corals will be competitive in the near future.

In one embodiment, an apparatus is disclosed for a subject comprising: a fabrication of a digital scan of a clonal organism and having a seeded micro-fragment of the subject attached thereto.

In one embodiment, the fabrication is 3D printed.

In one embodiment, the 3D printed fabrication comprises a thermoplastic filament.

In one embodiment, the fabrication is molded.

In one embodiment, the subject is a clonal organism.

In one embodiment, the clonal organism is a marine invertebrate.

In one embodiment, the marine invertebrate is a coral.

In one embodiment, the coral is selected from the group consisting of Acroporidae, Acropora, and Acropora hemprichii.

In one embodiment, the subject is selected from the group consisting of a human, a mammal, a reptile, a bird, a fish, an amphibian, and an invertebrate.

In one embodiment, the fabrication is cured under UV or visible light.

In one embodiment, a method is disclosed for manufacturing a scaffold for a subject comprising: scanning the subject to form a digital model of the subject; modifying a digital geometry of the digital model to form a modified digital model; fabricating the modified digital model to form a scaffold; and seeding a micro-fragment of the subject to the scaffold.

In one embodiment, the scaffold is cured under UV or visible light.

In one embodiment, the modifying step comprises selecting an area of the digital model to be flattened to form the modified digital model and wherein the modified digital model is a two dimensional (2D) base for micro-fragment adhesion.

In one embodiment, the fabrication step comprises a 3D printing with a thermoplastic filament to form a mold and filling the mold with an ink.

In one embodiment, the 3D printing is submerged with the thermoplastic filament in a liquid silicon.

In one embodiment, the thermoplastic filament comprises a polylactic acid (PLA).

In one embodiment, the fabrication step comprises a direct 3D printing with a syringe-based Fused Deposition Modeling (FDM) and an ink.

In one embodiment, the ink is a calcium carbonate photoinitiated (CCP) ink.

In one embodiment, the CCP ink comprises a calcium carbonate and a resin.

In one embodiment, the calcium carbonate: resin has an average ratio of 9:1 to 1:1.

In one embodiment, the calcium carbonate: resin has an average ratio of 7:3.

In one embodiment, the mold is recyclable at least 10 times.

### Results

Method A: 3D Printing with PLA and Molding with CCP Ink

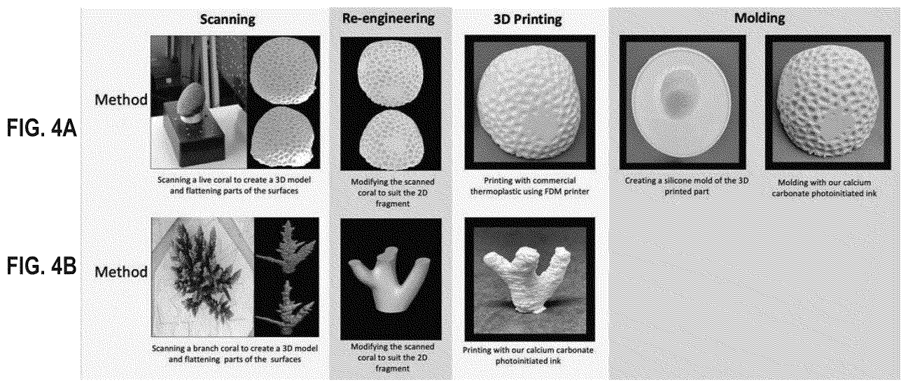

Using Method A, an Acropora hemprichii skeleton was 3D printed and molded with CCP ink. The final fabricated model maintained the spheroid shape and its grooved surfaces were also structurally preserved (FIG. 4). The flattened cuts were also unaffected by the molding process. The time needed for the molding process from start to finish was approximately 4-5 hours. This excludes the printing time needed for the positive mold model and the post-molding curing time, which both depend on the desired structure size of the coral. This confirmed the efficiency of Method A in molding coral models of outplant size and indicates the possibility of creating coral replicas at an efficient rate for large scale production.

Method B: Direct 3D Printing with CCP Ink

Using Method B, an Acropora hemprichii coral was scanned and a portion of it was 3D printed with CCP ink, yielding a mechanically stable skeleton that confirmed the printability of our developed CCP ink and displayed its ability to maintain structure after exposure to adequate UV light post-printing (FIG. 4). As the CCP ink was able to cure under UV laser beam within seconds, the printed structure did not require support material which further enhances the efficiency of CCP ink. As proof-of-concept, only the base of the coral was printed for preliminary assessment. Further experiments would include 3D printing of complete coral structures with CCP ink.

### Assessing Toxicity of PLA Corals

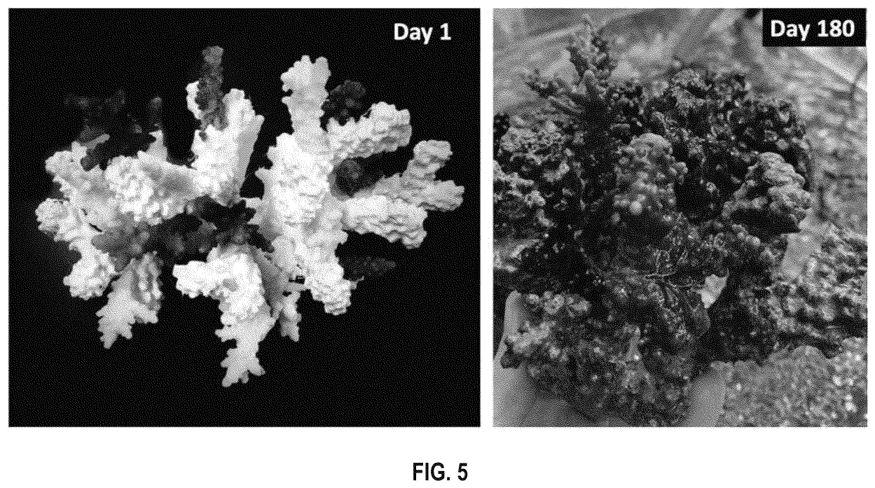

FIG. 5 illustrates assessing toxicity of PLA corals. Left: Acropora hemprichii skeleton 3D printed with PLA filament and seeded with live coral micro-fragments, Day 1. Right: Printed PLA coral with seeded micro-fragments after observation in a seawater tank for a period of 180 days. After a period of 180 days, it was found that the Acropora hemprichii skeleton assimilated into its environment with signs of visible growth and proliferation of the micro-fragments (FIG. 5). The growth of micro-algae on the printed coral also showed its functionality in the natural habitat (FIG. 5).

### Assessing Toxicity of CCP Corals

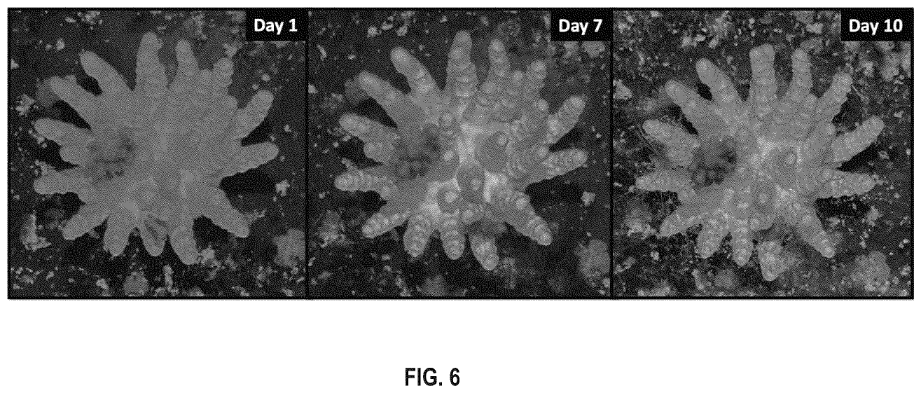

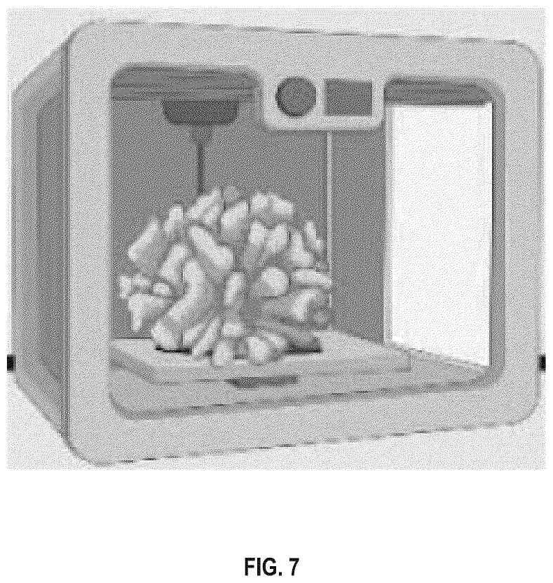

FIG. 6 illustrates an assessed toxicity of CCP corals. Day 1, Day 2, Day 3, molded Acropora tenuis skeleton with CCP ink and seeded with live Acropora hemprichii micro-fragments without using any bioadhesive glue. No effects were observed on the coral fragment by Day 10. After a period of 10 days, it was found that the Acropora tenuis skeleton assimilated into its environment with no signs of unfavorable effects such as bleaching on the live coral fragments (FIG. 6). The printed skeleton using CCP ink was able to tolerate the harsh environment of high salt concentration and a basic pH of around 8 without degradation or breaking down for a period of 10 days. Also, it showed no signs of toxicity or stress caused on the live coral fragments.

### DISCUSSION

Method A: 3D Printing with PLA and Molding with CCP

Method A, involving the molding process, was found to be fairly simple and easy to implement with a fast return time of approximately 4-5 hours. Once a mold is created, subsequent models can be molded within 10 minutes as the mold can be reused several times. Preliminary experiments conducted for proof-of-concept provided results with a suitable level of accuracy and good resolution. As different coral species vary in structural geometry and size, Method A offers a solution where molding can support structures of outplant size while the initial step of 3D printing can preserve the intricate geometries of the coral. The created molds allow ease of replication as many models can be fabricated using the same mold. An added advantage of this method is that the molds can easily be transported to different locations, without the need for a large infrastructure setup.

While molding is an efficient process for coral fabrication of small sized corals, it may not be efficient objects of larger diameters. It is important to note that the curing time increases with the size of the printed object. Also, larger-sized objects (greater than 10 cm) may result in ineffective curing due to the interior regions not being thoroughly solidified. This would lead to structure decay over time when placed underwater. Another factor to consider is that multiple varieties of corals would require the 3D printing and fabrication of new molds. This may lengthen production time considerably in large scale projects but can be overcome with adequate planning and equipment.

Method B: Direct 3D Printing with CCP Ink

Method B, consisting of direct 3D printing with eco-friendly inks, was found to be achievable using syringe-extrusion FDM to fabricate corals of small dimensions (<10 cm) without the need for support structures. This capability could be scaled up for models of larger diameters by using a multi-axis robotic 3D printer, which would provide more degrees of freedom for support. Method B is relatively faster than Method A as it eliminates the steps for molding, which require an additional 4-5 hours. An added advantage of direct 3D printing is the ability to customize each coral model with relative ease. As parameter changes can be implemented fairly quickly, each coral model can be efficiently printed with unique parameters. However, the resolution of these models was found to be lower than that of models fabricated using Method A due to the layer-by-layer approach of conventional 3D printing. On the other hand, Method A replicates the geometry of the coral using the molds. Also, Method B can become more time-consuming when printing complex coral models that may require support structures as additional parameter optimization and printer adjustments would be needed.

Considering the complementary advantages of both Methods A and B, disclosed embodiments propose a hybrid solution, 3D CoraPrint, involving both methods to expedite coral production for large-scale projects. Method A supports ease of reproducibility with relatively efficient return times and can facilitate production of small coral skeletons of sizes less than 10 cm. Meanwhile, Method B offers ease of customization and size scalability which would accommodate the 3D printing of larger skeletons.

### Printability of CCP Ink Using Syringe-Extrusion 3D Printer

The printability and shape fidelity of the CCP ink was evaluated using a syringe-extrusion FDM 3D printer with a UV laser beam mounted for layer-by-layer curing. The curing was extremely fast, with each layer being cured within seconds of exposure to the UV laser beam. Due to quick solidification, geometries with curvatures and minor overhangs can be 3D printed without the need for support structures as can be seen in the printed Acropora hemprichii model in FIG. 4. It is essential that the UV light exposure be introduced layer-by-layer simultaneously during printing to allow layers to solidify thoroughly while piling up and to prevent the material from sagging and losing shape.

The viscosity of the CCP ink was found to assist the printed construct in maintaining shape while printing. However, it also posed a minor challenge in 3D printing as larger volume syringes were needed to reduce shear stress. This restricted the nozzle diameter range to 0.60-0.077 cm, which affected the width of the ink strand. For increased resolution, the extruder would need to be modified to allow for smaller nozzle diameters while accounting for shear stress. It was also observed that infill types had to be carefully selected to be suitable for the base shape being printed. Further printing optimization is required in terms of printer speed, extruder relax and feed rates, layer height, wall thickness, and UV light intensity to achieve higher quality prints of increased complexity.

### Assessing Toxicity of PLA Corals

A toxicity study was performed to assess the effect of PLA filament on 3D printed corals seeded with live coral fragments. The 3D printed Acropora hemprichii skeleton was seeded with acroporids and pocilloporids. After a period of 180 days, it was observed that the live coral fragments were not affected by the PLA coral skeleton. This is a positive indication of the coral species' resilience and the PLA material's eco-friendliness to the natural coral habitat despite being a non-natural polymer. From these observations, it can be deduced that the synthesis of printing materials with better biocompatibility and likeliness to coral skeletal material may contribute to a harmonious coral habitat with minimal negative effects, if any. Additional studies would need to be conducted to further assess the toxicity of these new materials, such as CCP.

### Assessing Toxicity of CCP Corals

A toxicity study was performed to assess the effect of CCP ink on live coral fragments. An open-source STL file65 of Acropora Tenuis was 3D printed and molded with CCP ink. Live Acropora hemprichii fragments were observed over a period of 10 days. The fragments were attached without using any adhesive to solely observe the effect of CCP on the fragments without any additional factors. After 10 days, there were no changes observed on the coral fragments or the 3D object. This indicates that the CCP material has no immediate effect on the well-being of the coral fragments. Although 10 days of observation is a relatively short period, it provided preliminary insights to show that this ink has no immediate negative effect on the coral species.

### CONCLUSION

Departing from a baseline on the state-of-the art for 3D printing of coral skeletons, disclosed embodiments provide here a number of steps toward rendering this technology better suited for coral reef restoration. In particular, disclosed embodiments have developed two new printing approaches to generate 3D printed coral skeletons, each feasible. Most importantly, disclosed embodiments have demonstrated an active approach to bring these skeletons to life, a key innovation relative to the passive settlement of printed skeletons developed to-date. This is an essential step, as it allows control over the coral species that will be growing in the restored reef as well as, in more detail, selection of the genotypes that will be deployed, therefore providing a basis to combine two emerging technologies in coral reef restoration, (a) 3D printing to fast-track the development of coral skeletons, and (b) implantation of corals on the printing skeletons to deploy resilient corals, selected to be more thermal resilient than the stock that has been impacted already by marine heat waves. 3D printed restoration will also minimize environmental impacts, by reducing the source corals to micro-fragments obtained from the environment and selected, and propagated in a coral nursery prior to implantation. Scalability is a problem common to most existing 3D printing processes, both in size and cost. A learning curve bringing down the costs of 3D printing technology is being propelled by the myriad of applications, from the construction to the medical sector. The potential for 3D printing to be a cost-effective approach to restore coral reefs at scale (i.e. 10's of hectare project sizes) is likely to be propelled by rapid developments in 3D printing using concrete for the construction industry, as it faces similar challenges in scalability, cost-efficiency and the carbonate materials involved. Transferring the 3D printing revolution to help restore coral reefs can be propelled further by the UN Decade of Ecosystem Restoration and the forthcoming G20 Coral Reef R&D Accelerator Platform. Disclosed embodiments emphasize the importance of developing interdisciplinary teams to deliver on this potential.

### CCP and CPP

### Characterization of CCP Ink and 3D Printed CCP

Described embodiments of the disclosed invention may include applications of printing techniques including not only for calcium carbonate photoinitiated (CCP) ink but also for calcium phosphate paste (CPP) applications as well such as in bone grafting operations. Such bong grafting operations may include subjects including, but not limited to: a human, a mammal, a reptile, a bird, a fish, an amphibian, and an invertebrate. In some disclosed embodiments, the constitution of CCP or CPP may consist of approximately 20-75% resin and the remaining calcium carbonate/other minerals.

| | | New | |
|---|---|---|---|
| | The compound | % | Note |
| 1 | Soybean oil, epoxidized | 0-77 | Other plant-based epoxidized oils |
| | acrylate | | such as sesame oil, linseed oil, |
| | | | castor oil and date seed oil |
| 2 | Isooctyl acrylate | 0-31 | Acts as a thickening agent for |
| | | | improving the texture of the |
| | | | formulation. |
| 3 | Di(trimethylolpropane) | 0-11 | The monomers are chosen based |
| | tetraacrylate | | on the mechanical property |
| 4 | 1,6-Hexanediol | 0-11 | of the final 3D printed object |
| | diacrylate | | |
| 5 | 2-Hydroxy-2-methyl- | 0-6 | Photoinitiator, other plausible |
| | propiophenone | | examples include but are not |
| | or other | | limited to Camphorquinone (CQ), |
| | Photoinitiators | | Phenanthrenequinone (PQ) falling |
| | | | within the adequate wavelength. |
| | | | (Max Abs: 400 nm) |

The above chemical break-down is the basic composition of the disclosed resin. The addition of calcium carbonate in the range of approximately 10-75% to the resin creates CCP, which may be used in coral restoration applications. Moreover, the exchange of calcium carbonate to calcium phosphate within the same range allows the formation of CPP, which finds its use in bone grafting. It is essential to highlight that both CCP and CPP can be applied interchangeably for both intended applications. Additional components, such as minerals, may be added to further optimize the properties of CCP or CPP in terms of compositional benefits as well as printability. An example of such minerals includes magnesium, zinc, and iron oxide. Their microcrystal, nanoparticle composition would be ideal for employment within bone grafting and coral restoration as it adds additional elements such as morphological and porosity benefits which maximizes the potential of the material.

Following is some preliminary data to support the functionality and the use of CCP: (a) 3D printing technology; (b) Coral Restoration-Characterization using Scanning Electron Microscopy (SEM) and Survival Assessment and Monitoring with Planted Corals; (c) Bone grafting-Scaffold Fabrication Using Vat Polymerization Technology for 3D Printing and Biocompatibility studies.

### 3D Printing Technology

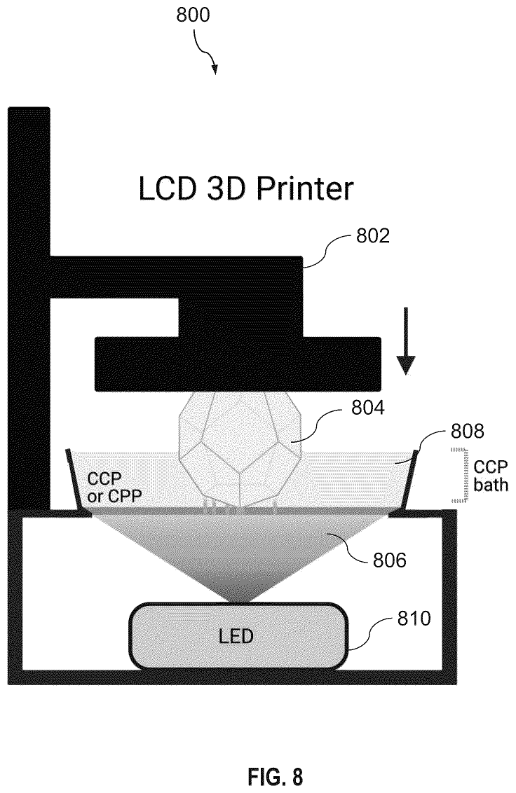

Referring to FIG. 8, a Liquid Crystal Display (LCD) 3D Printer configuration 800 is illustrated having an LCD 3D Printer 802. Additional to the molding and excursion-based printing, CCP and CPP can be 3D-printed using stereolithography (SLA), which encompass Liquid Crystal Display (LCD) and Digital Light Processing (DLP). The utilization of SLA allows enhanced printing resolution, scalability, and repeatability. This is crucial for the intricate details required for mimicking coral and bone 3D structures. A higher resolution allows for the execution of finer structures which allows for the creation of porosity by design, closely mimicking nature. The scale at which the printing technology works would allow the scope required for coral restoration. By the disclosed design, repeatability is important to have analogy across the design structures and maintain the disclosed material's integrity.

All STL files may be 3D printed with the CCP materials using LCD 3D printing technology. The modified models as STL files may contain 3D model data describing the geometry of the coral structures. The 3D printer slicing software may utilize the STL data to create a G-code file containing X, Y, and Z instructions for the 3D printer. The G-code files may be sent to the printer for 3D printing. The structures 804 may be printed using an LCD printer, such as, on the default setting with a UV exposure 806 time of approximately 15 seconds per layer. In one disclosed configuration, the UV exposure may be performed, for example, by LED 810 as illustrated in FIG. 8. Post-processes with UV ovens and washing may be performed across different SLA printing. For example, in one select embodiment, after printing, the structures 804 may be washed (e.g., in bath 808), such as with isopropanol, for approximately 30 minutes, for example, using FormWash. The bath may comprise a CCP or CPP bath in accordance with select embodiments. After washing, a UV oven set with a temperature of approximately 40 degrees Celsius may be employed to cure the structures for approximately 45 minutes.

### Coral Restoration

### Microstructural Analysis of CCP-Based Structures Using SEM

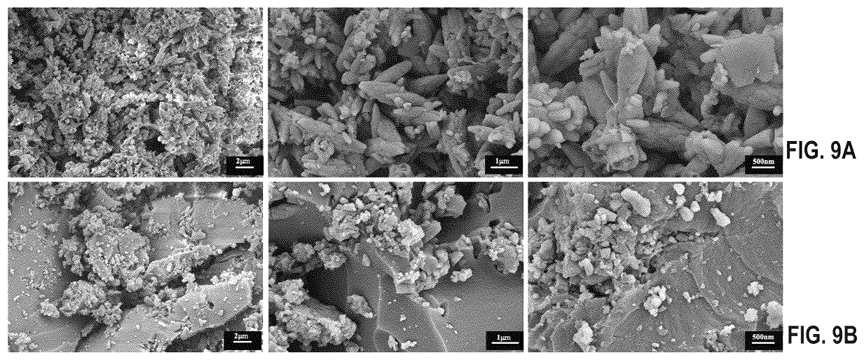

FIGS. 9(A) and 9(B) illustrate SEM images of the calcium carbonate and calcium carbonate photoinitiated CCP, respectively. The SEM images of calcium carbonate and calcium carbonate photoinitiated (CCP) are characterized to understand the distribution of the material on a micrometer scale. In accordance with disclosed embodiments, it can be confidently said the CCP is free of surface fractures as well as contaminants/corrosion based upon the images attained. Additionally, the CCP paste does not form aggregates and the distribution on the surface is relatively homogeneous, even at a nanometer scale (500 nm), which deems CCP as an appropriate and potentially promising material choice in accordance with disclosed embodiments.

### Survival Assessment and Monitoring of Planted Corals on CCP-Based Structures

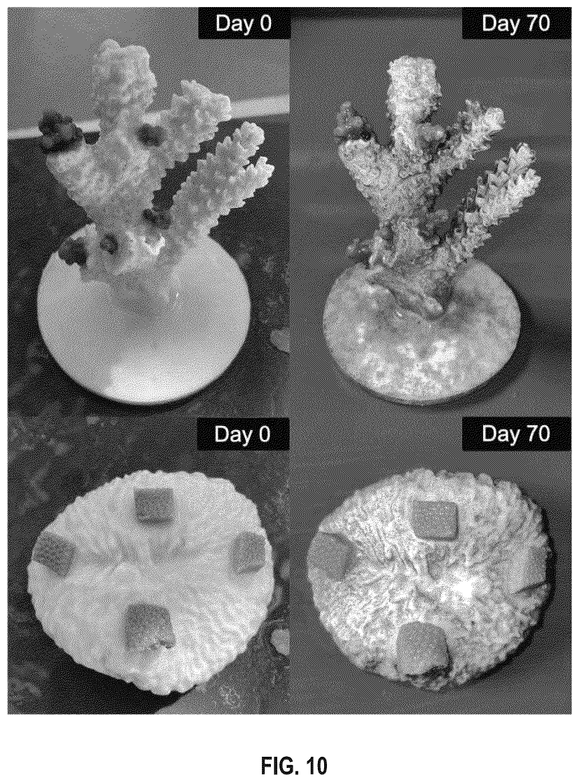

Referring to FIG. 10, Acropora Tricolor 3D printed structures seeded with Acropora hemprichii fragments (top) and Fungiidae 3D printed structures seeded with Porites Lobata fragments (bottom) are illustrated. In disclosed embodiments, an experiment was conducted on five structures of Acropora Tricolor 3D and five structures of Fungiidae. The 3D printed coral structures were maintained in an outdoor tank, and a significant number of fragments survived, as shown in FIG. 10. As shown, disclosed embodiments illustrate the material being benign and hence, not harmful to marine life. The intricacy of the printed structure in accordance with disclosed embodiments is also detailed.

Bone grafting 3D printing and creating a novel bone scaffold.

### Results

### Scaffold Fabrication Using Vat Polymerization Technology for 3D Printing

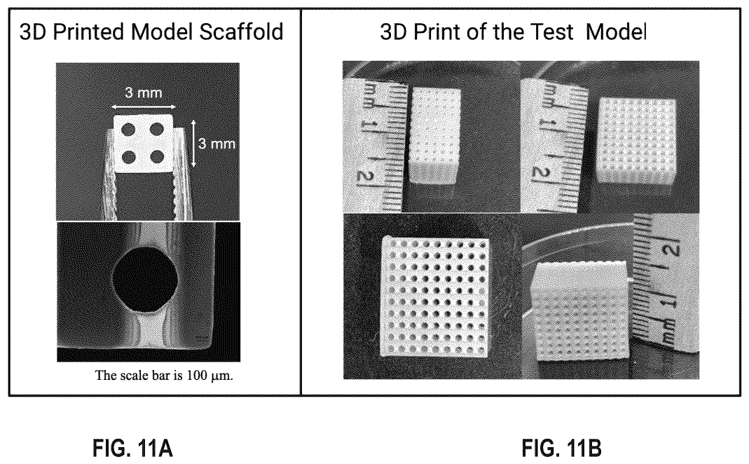

Referring to FIGS. 11A and 11B, to evaluate printability using Vat polymerization technology, a complex model was 3D printed with the default settings on an Elegoo LCD 3D printer. The results showed that the inner channels were accurately captured, and the overall model closely resembled the original 3D CAD design, as shown in FIG. 11B. After printing, the model was washed in 70% ethanol for approximately 60 minutes and cured in a UV oven set at approximately 40 degrees Celsius for approximately an additional 60 minutes. Sixty 3D-printed calcium carbonate and calcium phosphate scaffolds for bone substitutes were produced simultaneously in just approximately 30 minutes, as shown in FIG. 11A. The scaffolds were created using default settings and a UV exposure time of approximately 15 seconds per layer. Afterward, they were washed with 70% ethanol for approximately 60 minutes and post-cured in a UV oven set at approximately 40 degrees Celsius. The scaffolds were then rinsed with sterilized Milli-Q water and PBS before being soaked overnight in PBS and seeded with cells.

### Biocompatible Study on the CCP and CPP Materials

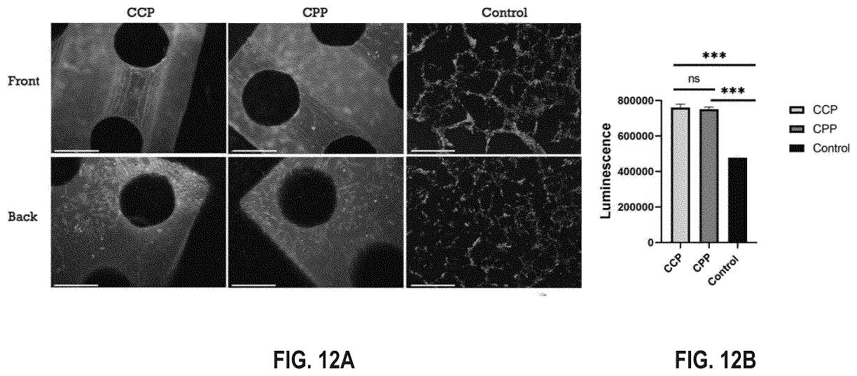

FIG. 12A illustrates live/dead cell viability assay of hDF on 3D printed CCP and CPP 24 hrs post seeding. FIG. 12B illustrates cell viability in 3D CCP and CPP for one day post seeding. Human dermal fibroblast (hDF) cells were seeded on CCP and CPP scaffolds to evaluate cytocompatibility. Cell viability and metabolic activity were subsequently analyzed. The cells appeared stretched and elongated, with well-defined actin fibers (FIG. 12A), exhibiting high cell viability one-day post-seeding, indicated by the presence of a high number of live cells compared to dead cells. Significantly, higher metabolic activity was also observed in cells cultured in the presence of the CCP and CPP scaffolds when compared to the 2D controls, as shown in FIG. 12B. Notably, a significant change in cell morphology was seen compared to 2D cultures, demonstrating a positive effect of the CCP and CPP scaffolds on the cells.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### EXAMPLES

### Example 1

### Materials and Methods

Disclosed embodiments have developed a coral-like printable Calcium Carbonate Photoinitiated ink from natural eco-friendly materials by mixing Calcium Carbonate with a commercially available photocurable resin. To optimize the viscosity of the material for printability, the ratios of Calcium Carbonate and resin were adjusted to reach the desired mechanical properties at 70% and 30% respectively. The CCP ink resembles the natural coral composition and hence, could be a potentially better alternative for printing corals as compared to cement and other materials. This viscous material has the ability to solidify with exposure to UV laser. Its characteristics are essential in our proposed printing method, allowing to print and solidify objects simultaneously and produce an eco-friendly complex structure.

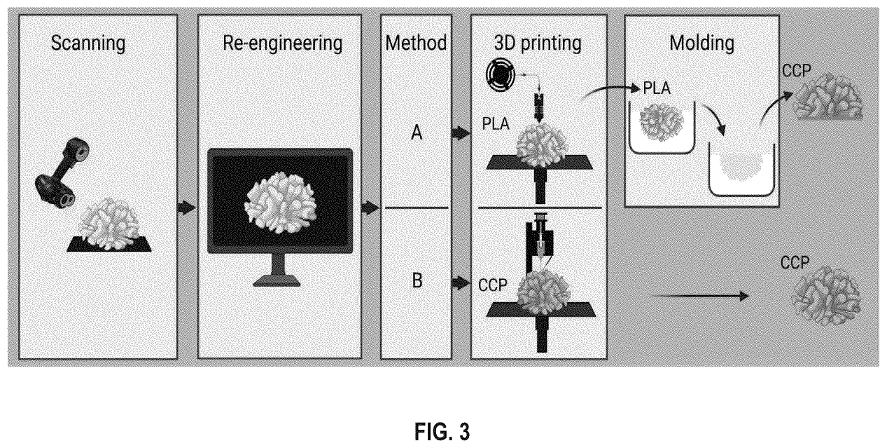

For both Methods A and B, a Creaform® scanning system, GoScan, was used to scan a live coral to convert the coral's physical structure to a Computer-Aided Design (CAD) model for further modification (FIG. 3). Method A involves 3D printing and molding with calcium carbonate photoinitiated ink (CCP) (FIG. 3). Method B involves direct 3D printing with CCP (FIG. 3). This system allows scanning of complex structures, which is much needed in this application. The scanned coral file was modified according to the printing requirements using NX software (FIG. 3).

Disclosed embodiments then flattened certain areas on the surface of the CAD model to form leveled 2D features. This is done to facilitate the attachment of the base of the micro-fragments to the coral structure and eliminates the need for further adjustments post-printing, such as cutting, trimming, and sanding.

Method A: 3D Printing with PLA and Molding with CCP Ink

In Method A, the modified CAD model was set to the desired printing parameters and printed using a standard FDM 3D printer loaded with thermoplastic filament. The 3D printed skeleton was submerged in liquid silicon and left to dry for 3 hours to create a negative silicon mold. The mold was filled with CCP ink and was placed under UV light treatment for approximately 10 minutes to form a 3D coral replicate with modifications for 2D micro-fragment adhesion. An Acropora hemprichii of a semi-circle shape and a size of 7×7×9 cm was fabricated using this method (FIG. 4).

Method B: Direct 3D Printing with CCP Ink

In Method B, the modified CAD model was set to the desired printing parameters and printed using our modified syringe-based extrusion FDM printer. A UV laser was mounted onto the side of the syringe extruder at a specific angle to allow curing of the construct during printing without affecting material extrusion. For proof-of-concept, the base of a branched coral, Acropora hemprichii, of size 2×2×3 cm was 3D printed using this method. The 3D printed model formed an eco-friendly coral replica with modifications for 2D micro-fragment adhesion.

### Assessing Toxicity of PLA to Corals

To evaluate the toxicity of commercial thermoplastic materials, Method A was used to 3D print an Acropora hemprichii skeleton with PLA filament. Micro-fragments of acroporids and pocilloporids were attached to the surface. Although the two species may cause aggressive behavior, the main purpose of the study was to observe toxicity of PLA towards both species. For the purpose of this study, it was not required to print a structure of the same species as the fragments. The coral replica was planted in a coral tank and observed for micro-algae growth and fragment sustainability for a period of 180 days.

### Assessing Toxicity of CCP Corals

The toxicity test of CCP material was conducted by 3D printing an Acropora Tenuis skeleton of size 7.6×7.6×4 cm with PLA filament and creating a negative silicon mold. The STL model was obtained from an open-source 3D model platform.67 The mold was filled with CCP ink, left to solidify for 10 minutes and then cured in a UV and heat oven (40° C.) for about an hour. The CCP skeleton was seeded with live micro-fragments of Acropora hemprichii by wedging them mechanically on to its surface. Bioadhesive glue was not used as the aim of the study was to solely observe the effect of printed CCP ink on live micro-fragments. The coral was placed in a seawater tank and observed for 10 days.

### REFERENCES

The following references are referred to above and are incorporated herein by reference:
1 Stolarski, J.; Coronado, I.; Murphy, J. G.; Kitahara, M. V.; Janiszewska, K.; Mazur, M.; Gothmann, A. M.; Bouvier, A.-S.; Marin-Carbonne, J.; Taylor, M. L.; Quattrini, A. M.; McFadden, C. S.; Higgins, J. A.; Robinson, L. F.; Meibom, A., “A Modern Scleractinian Coral with a Two-Component Calcite-Aragonite Skeleton,” Proc. Natl. Acad. Sci 118, e2013316117 (2021).
2. Fine, M.; Cinar, M.; Voolstra, C. R.; Safa, A.; Rinkevich, B.; Laffoley, D.; Hilmi, N.; Allemand, D., “Coral Reefs of the Red Sea-Challenges and Potential Solutions,” Reg. Stud. Mar. Sci. 25, 100498 (2019).
3. Pandolfi, J. M.; Connolly, S. R.; Marshall, D. J.; Cohen, A. L., “Projecting Coral Reef Futures Under Global Warming and Ocean Acidification,” Science. 333, 418-422 (2011).
4. Duarte, C. M.; Agusti, S.; Barbier, E.; Britten, G. L.; Castilla, J. C.; Gattuso, J.-P.; Fulweiler, R. W.; Hughes, T. P.; Knowlton, N.; Lovelock, C. E.; Lotze, H. K.; Predragovic, M.; Poloczanska, E.; Roberts, C.; Worm, B., “Rebuilding Marine Life,” Nature, 580, 39-51 (2020).
5. Bayraktarov, E.; Banaszak, A. T.; Montoya Maya, P.; Kleypas, J.; Arias-González, J. E.; Blanco, M.; Calle-Triviño, J.; Charuvi, N.; Cortés-Useche, C.; Galván, V.; García Salgado, M. A.; Gnecco, M.; Guendulain-García, S. D.; Hernández Delgado, E. A.; Marín Moraga, J. A.; Maya, M. F.; Mendoza Quiroz, S.; Mercado Cervantes, S.; Morikawa, M.; Nava, G.; Pizarro, V.; Sellares-Blasco, R. I.; Suleimán Ramos, S. E.; Villalobos Cubero, T.; Villalpando, M. F.; Frías-Torres, S., “Coral Reef Restoration Efforts in Latin American Countries and Territories,” PLOS One, 15, e0228477 (2020).
6. Li, X.; Bellerby, R.; Craft, C.; Widney, S. E., “Coastal Wetland Loss, Consequences, and Challenges for Restoration,” Anthr. Coasts, 15, 1-15 (2018).
7. Lirman, D.; Schopmeyer, S., “Ecological Solutions to Reef Degradation: Optimizing Coral Reef Restoration in the Caribbean and Western Atlantic,” PeerJ., 4, e2597 (2016).
8. Schmidt-Roach, S.; Duarte, C. M.; Hauser, C. A. E.; Aranda, M., “Beyond Reef Restoration: Next-Generation Techniques for Coral Gardening, Landscaping, and Outreach,” Front. Mar. Sci., 7, 1-8 (2020).
9. Waltham, N. J.; Elliott, M.; Lee, S. Y.; Lovelock, C.; Duarte, C. M.; Buelow, C.; Simenstad, C.; Nagelkerken, I.; Claassens, L.; Wen, C. K. C.; Barletta, M.; Connolly, R. M.; Gillies, C.; Mitsch, W. J.; Ogburn, M. B.; Purandare, J.; Possingham, H.; Sheaves, M., “UN Decade on Ecosystem Restoration 2021-2030-What Chance for Success in Restoring Coastal Ecosystems?,” Front. Mar. Sci., 7, 1-5 (2020).
10. SCIENCE, “News at a Glance,” Science, 370, 1382-1383 (2020).
11. Schopmeyer, S. A.; Lirman, D.; Bartels, E.; Gilliam, D. S.; Goergen, E. A.; Griffin, S. P.; Johnson, M. E.; Lustic, C.; Maxwell, K.; Walter, C. S., “Regional Restoration Benchmarks for Acropora Cervicornis.,” Coral Reefs, 36, 1047-1057 (2017).
12. dela Cruz, D. W.; Rinkevich, B.; Gomez, E. D.; Yap, H. T., “Assessing an Abridged Nursery Phase for Slow Growing Corals Used in Coral Restoration,” Ecol. Eng., 84, 408-415 (2015).
13. Lange, C.; Ratoi, L.; Co, D. L., “Reformative Coral Habitats,” RE Anthr. Des. Age Humans-Proc. 25th Int. Conf. Comput. Archit. Des. Res. Asia, CAADRIA, 2, 465-474 (2020).
14. Levy, G.; Shaish, L.; Haim, A.; Rinkevich, B., “Mid-Water Rope Nursery-Testing Design and Performance of a Novel Reef Restoration Instrument,” Ecol. Eng., 36, 560-569 (2010).
15. Attaran, M., “The Rise of 3-D Printing: The Advantages of Additive Manufacturing over Traditional Manufacturing,” Bus. Horiz., 60, 677-688 (2017).
16. Mohammed, J. S., “Applications of 3D Printing Technologies in Oceanography,” Methods Oceanogr., 17, 97-117 (2016).
17. Wangpraseurt, D.; You, S.; Azam, F.; Jacucci, G.; Gaidarenko, O.; Hildebrand, M.; Kühl, M.; Smith, A. G.; Davey, M. P.; Smith, A.; Deheyn, D. D.; Chen, S.; Vignolini, S., “Bionic 3D Printed Corals,” Nat. Commun., 11, 1748 (2020).
18. Ruhl, E. J.; Dixson, D. L., “3D Printed Objects Do Not Impact the Behavior of a Coral-Associated Damselfish or Survival of a Settling Stony Coral,” PLOS One, 14, e0221157 (2019).
19. Lee, J.-Y.; An, J.; Chua, C. K., “Fundamentals and Applications of 3D Printing for Novel Materials,” Appl. Mater. Today., 7, 120-133 (2017).
20. Trilsbeck, M.; Gardner, N.; Fabbri, A.; Haeusler, M. H.; Zavoleas, Y.; Page, M., “Meeting in the Middle: Hybrid Clay Three-Dimensional Fabrication Processes for Bio-Reef Structures,” Int. J. Archit. Comput., 17, 148-165 (2019).
21. Pérez-Pagán, B. S.; Mercado-Molina, A. E., “Evaluation of the Effectiveness of 3D-Printed Corals to Attract Coral Reef Fish at Tamarindo Reef, Culebra, Puerto Rico,” Conserv. Evid., 15, 43-47 (2018).
22. Pacewicz, K.; Sobotka, A.; Gołek, L., “Characteristic of Materials for the 3D Printed Building Constructions by Additive Printing,” MATEC Web Conf., 222, 01013 (2018).
23. Song, L.; Jiang, Q.; Shi, Y.-E.; Feng, X.-T.; Li, Y.; Su, F.; Liu, C., “Feasibility Investigation of 3D Printing Technology for Geotechnical Physical Models: Study of Tunnels,” Rock Mech. Rock Eng., 51, 2617-2637 (2018).
24 Gutierrez-heredia, L.; Keogh, C.; Keaveney, S.; Reynaud, E. G., “3D Printing Solutions for Coral Studies, Education and Monitoring,” News J. Int. Soc. Reef Stud., 31, 39-44 (2016).
25. Walker, M.; Humphries, S., “3D Printing: Applications in Evolution and Ecology,” Ecol. Evol., 9, 4289-4301 (2019).
26. Tarazi, E.; Parnas, H.; Lotan, O.; Zoabi, M.; Oren, A.; Josef, N.; Shashar, N., “Nature-Centered Design: How Design Can Support Science to Explore Ways to Restore Coral Reefs,” Des. J., 22, 1619-1628 (2019).
27. Suh, Y. J.; Lim, T. H.; Choi, H. S.; Kim, M. S.; Lee, S. J.; Kim, S. H.; Park, C. H., “3D Printing and NIR Fluorescence Imaging Techniques for the Fabrication of Implants,” Materials., 13, 4819 (2020).
28. Hartings, M. R.; Ahmed, Z., “Chemistry from 3D Printed Objects,” Nat. Rev. Chem., 3, 305-314 (2019).
29. Abeykoon, C.; Sri-Amphorn, P.; Fernando, A., “Optimization of Fused Deposition Modeling Parameters for Improved PLA and ABS 3D Printed Structures,” Int. J. Light. Mater. Manuf., 3, 284-297 (2020).
30. Salavati, M.; Yousefi, A. A., “Polypropylene-Clay Micro/Nanocomposites as Fused Deposition Modeling Filament: Effect of Polypropylene-g-Maleic Anhydride and Organo-Nanoclay as Chemical and Physical Compatibilizers,” Iran. Polym. J., 28, 611-620 (2019).
31 Sundaramurthi, D.; Rauf, S.; Hauser, C., “3D Bioprinting Technology for Regenerative Medicine Applications,” Int. J. Bioprinting, 2, 9-26 (2016).
32. Bakhtiar, S. M.; Butt, H. A.; Zeb, S.; Quddusi, D. M.; Gul, S.; Dilshad, E., “3D Printing Technologies and Their Applications in Biomedical Science,” Omics Technologies and Bio-Engineering, 1, 167-189 (2018).
33. Susapto, H. H.; Alhattab, D. M.; Abdelrahman, S. A.; Khan, Z., “Ultrashort Peptide Bioinks Support Automated Printing of Large-Scale Constructs Assuring Long-Term Survival of Printed Tissue Constructs,” Nano Lett., 21, 2719-2729 (2021).
34. Kahin, K.; Khan, Z.; Albagami, M.; Usman, S.; Bahnshal, S.; Alwazani, H.; Majid, M. A.; Rauf, S.; Hauser, C., “Development of a Robotic 3D Bioprinting and Microfluidic Pumping System for Tissue and Organ Engineering,” Microfluidics, BioMEMS, and Medical Microsystems XVII, 10875, 130-139 (2019).
35. Kumta, S.; Kumta, M.; Jain, L.; Purohit, S.; Ummul, R., “A Novel 3D Template for Mandible and Maxilla Reconstruction: Rapid Prototyping Using Stereolithography,” Indian J. Plast. Surg., 48, 263-273 (2015).
36. Elomaa, L.; Keshi, E.; Sauer, I. M.; Weinhart, M., “Development of GelMA/PCL and DECM/PCL Resins for 3D Printing of Acellular in Vitro Tissue Scaffolds by Stereolithography,” Mater. Sci. Eng. C., 112, 110958 (2020).
37. Peele, B. N.; Wallin, T. J.; Zhao, H.; Shepherd, R. F., “3D Printing Antagonistic Systems of Artificial Muscle Using Projection Stereolithography,” Bioinspir. Biomim., 10, 055003 (2015).
38. Xing, H.; Zou, B.; Liu, X.; Wang, X.; Huang, C.; Hu, Y., “Fabrication Strategy of Complicated Al₂O₃—Si₃N₄ Functionally Graded Materials by Stereolithography 3D Printing,” J. Eur. Ceram. Soc., 40, 5797-5809 (2020).
39. Piironen, K.; Haapala, M.; Talman, V.; Järvinen, P.; Sikanen, T., “Cell Adhesion and Proliferation on Common 3D Printing Materials Used in Stereolithography of Microfluidic Devices,” Lab on a Chip., 20, 2372-2382 (2020).
40. Awad, A.; Trenfield, S. J.; Goyanes, A.; Gaisford, S.; Basit, A. W., “Reshaping Drug Development Using 3D Printing,” Drug Discov. Today., 23, 1547-1555 (2018).
41. Tumbleston, J. R.; Shirvanyants, D.; Ermoshkin, N.; Janusziewicz, R.; Johnson, A. R.; Kelly, D.; Chen, K.; Pinschmidt, R.; Rolland, J. P.; Ermoshkin, A.; Samulski, E. T.; DeSimone, J. M., “Continuous Liquid Interface Production of 3D Objects,” Science, 347, 1349-1352 (2015).
42. Keshan Balavandy, S.; Li, F.; Macdonald, N. P.; Maya, F.; Townsend, A. T.; Frederick, K.; Guijt, R. M.; Breadmore, M. C., “Scalable 3D Printing Method for the Manufacture of Single-Material Fluidic Devices with Integrated Filter for Point of Collection Colourimetric Analysis,” Anal. Chim. Acta., 1151, 238101 (2021).
43. Jing, J.; Chen, Y.; Shi, S.; Yang, L.; Lambin, P., “Facile and Scalable Fabrication of Highly Thermal Conductive Polyethylene/Graphene Nanocomposites by Combining Solid-State Shear Milling and FDM 3D-Printing Aligning Methods,” Chem. Eng. J., 402, 126218 (2020).
44. Yang, T.-C.; Yeh, C.-H., “Morphology and Mechanical Properties of 3D Printed Wood Fiber/Polylactic Acid Composite Parts Using Fused Deposition Modeling (FDM): The Effects of Printing Speed,” Polymers, 12, 1334 (2020).
45. Placone, J. K.; Engler, A. J., “Recent Advances in Extrusion-Based 3D Printing for Biomedical Applications,” Adv. Healthc. Mater., 7, 1701161 (2018).
46. Žarko, J.; Vladić, G.; Pál, M.; Dedijer, S., “Influence of Printing Speed on Production of Embossing Tools Using FDM 3d Printing Technology,” J. Graph. Eng. Des., 8, 19-27 (2017).
47. Swetham, T.; Madhana, K.; Reddy, M.; Huggi, A.; Kumar, M. N., “A Critical Review on of 3D Printing Materials and Details of Materials Used in FDM,” Int. J. Sci. Res. Sci. Eng, 3., 2, 353-361 (2017).
48. Dudek, P., “FDM 3D Printing Technology in Manufacturing Composite Elements,” Arch. Metall. Mater., 58, 1415-1418 (2013).
49. Voet, V. S. D.; Strating, T.; Schnelting, G. H. M.; Dijkstra, P.; Tietema, M.; Xu, J.; Woortman, A. J. J.; Loos, K.; Jager, J.; Folkersma, R., “Biobased Acrylate Photocurable Resin Formulation for Stereolithography 3D Printing,” ACS Omega, 3, 1403-1408 (2018).
50. Li, J.; Pumera, M., “3D Printing of Functional Microrobots,” Chem. Soc. Rev., 50, 2794-2838 (2021).
51. Wang, L.; Luo, Y.; Yang, Z.; Dai, W.; Liu, X.; Yang, J.; Lu, B.; Chen, L., “Accelerated Refilling Speed in Rapid Stereolithography Based on Nano-Textured Functional Release Film,” Addit. Manuf., 29, 100791 (2019).
52. Kruszyński, K. J.; van Liere, R., “Tangible Props for Scientific Visualization: Concept, Requirements, Application,” Virtual Real., 13, 235-244 (2009).
53. Li, L. G.; Xiao, B. F.; Fang, Z. Q.; Xiong, Z.; Chu, S. H.; Kwan, A. K. H., “Feasibility of Glass/Basalt Fiber Reinforced Seawater Coral Sand Mortar for 3D Printing,” Addit. Manuf., 37, 101684 (2021).
54. Gutierrez-Heredia, L.; Keogh, C.; Reynaud, E. G., “Assessing the Capabilities of Additive Manufacturing Technologies for Coral Studies, Education, and Monitoring,” Front. Mar. Sci., 5, 1-12 (2018).
55. Liu, J.; Erol, O.; Pantula, A.; Liu, W.; Jiang, Z.; Kobayashi, K.; Chatterjee, D.; Hibino, N.; Romer, L. H.; Kang, S. H.; Nguyen, T. D.; Gracias, D. H., “Dual-Gel 4D Printing of Bioinspired Tubes,” ACS Appl. Mater. Interfaces, 11, 8492-8498 (2019).
56. Boström-Einarsson, L.; Babcock, R. C.; Bayraktarov, E.; Ceccarelli, D.; Cook, N.; Ferse, S. C. A.; Hancock, B.; Harrison, P.; Hein, M.; Shaver, E.; Smith, A.; Suggett, D.; Stewart-Sinclair, P. J.; Vardi, T.; McLeod, I. M., “Coral Restoration-A Systematic Review of Current Methods, Successes, Failures and Future Directions,” PLOS One, 15, e0226631 (2020).
57. Reef Design Lab. MARS Modular Artificial Reef Structure. https://www.reefdesignlab.com/(accessed Apr. 27, 2021).
58. Maddela, N. R., García Cruzatty, L. C., Chakraborty, S., “Advances in the domain of environmental biotechnology,” Springer Nature Singapore Pte Ltd. https://doi.org/10.1007/978-981-15-8999-7 (2021).
59. Shefy, D.; Shashar, N.; Rinkevich, B., “Exploring Traits of Engineered Coral Entities to Be Employed in Reef Restoration,” J. Mar. Sci. Eng., 8, 1038 (2020).
60. Chan, W. Y.; Peplow, L. M.; Menéndez, P.; Hoffmann, A. A.; van Oppen, M. J. H., “Interspecific Hybridization May Provide Novel Opportunities for Coral Reef Restoration,” Front. Mar. Sci., 5, 1-15 (2018).
61. Chamberland, V. F.; Petersen, D.; Guest, J. R.; Petersen, U.; Brittsan, M.; Vermeij, M. J. A., “New Seeding Approach Reduces Costs and Time to Outplant Sexually Propagated Corals for Reef Restoration,” Sci. Rep., 7, 18076 (2017).
62. Young, G. C.; Dey, S.; Rogers, A. D.; Exton, D., “Cost and Time-Effective Method for Multi-Scale Measures of Rugosity, Fractal Dimension, and Vector Dispersion from Coral Reef 3D Models,” PLOS One, 12, e0175341 (2017).
63. Gómez-Lemos, L. A.; Doropoulos, C.; Bayraktarov, E.; Diaz-Pulido, G., “Coralline Algal Metabolites Induce Settlement and Mediate the Inductive Effect of Epiphytic Microbes on Coral Larvae,” Sci. Rep., 8, 17557 (2018).
64. Tebben, J.; Motti, C. A.; Siboni, N.; Tapiolas, D. M.; Negri, A. P.; Schupp, P. J.; Kitamura, M.; Hatta, M.; Steinberg, P. D.; Harder, T., “Chemical Mediation of Coral Larval Settlement by Crustose Coralline Algae,” Sci. Rep., 5, 10803 (2015).
65. Rinkevich, B., “Conservation of Coral Reefs through Active Restoration Measures: Recent Approaches and Last Decade Progress,” Environ. Sci. Technol., 39, 4333-4342 (2005).
66. Berman, B., “3-D Printing: The New Industrial Revolution,” Bus. Horiz., 55, 155-162 (2012).
67. MakerBot. Cryohabitat Coral Pack. https://www.thingiverse.com/thing: 2033856 (accessed Mar. 17, 2021)

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

1. An apparatus comprising:
a digital scanner for scanning a subject to produce an image;
a first system configured to produce a first replicate of the subject, the first system comprising:
a 3-D printer configured to receive the image to produce a first 3-D printed scaffold;
a mold for creating a negative mold of the first 3-D printed scaffold to produce the first replicate of the subject;
a UV light source to treat the first replicate of the subject; and
a second system configured to directly 3-D print a second replicate of the subject, the second system comprising:
a 3-D printer configured with a syringe-based extrusion printer to produce a second 3-D printed scaffold from the image,
wherein a UV laser is mounted to a syringe extruder of the syringe-based extrusion printer to cure a construct of the second 3-D printed scaffold during printing without affecting material extrusion.

2. (canceled)

3. The apparatus of claim 1, wherein the 3-D printer of the first and second system is configured to print with a thermoplastic filament.

4. (canceled)

5. The apparatus of claim 1, wherein the subject is a clonal organism.

6. The apparatus of claim 5, wherein the clonal organism is a marine invertebrate.

7. The apparatus of claim 6, wherein the marine invertebrate is a coral.

8. The apparatus of claim 7, wherein the coral is selected from the group consisting of Acroporidae, Acropora, and Acropora hemprichii.

9. The apparatus of claim 1, wherein the subject is selected from the group consisting of a human, a mammal, a reptile, a bird, a fish, an amphibian, and an invertebrate.

10-37. (canceled)

38. The apparatus of claim 1, wherein the 3D printer of the first and second system is configured to print the first and second 3-D printed scaffold from printable calcium carbonate photoinitiated (CCP) ink or calcium phosphate paste (CPP).

39. The apparatus of claim 38, wherein the printable calcium carbonate photoinitiated (CCP) ink comprises mixed calcium carbonate and photocurable resin.

40. The apparatus of claim 39, wherein a ratio of the mixed calcium carbonate to photocurable resin is 70% to 30%, respectively.

41. The apparatus of claim 1, wherein the negative mold is configured to receive calcium carbonate photoinitiated (CCP) ink therein to create the first replicate of the subject.

42. The apparatus of claim 1, wherein the negative mold comprises a silicon mold.

43. The apparatus of claim 1, wherein the syringe-based extrusion printer is a fused deposition modeling (FDM) printer.

44. The apparatus of claim 1, wherein the first replicate and the second replicate of the subject are coral replicate skeletons configured to receive an implantation of corals on surfaces thereof.

45. The apparatus of claim 44, wherein select areas of the first replicate and the second replicate are flattened to create a 2D base for micro-fragment adhesion.

46. The apparatus of claim 1, wherein the first system is configured to produce the first replicate of a size less than 10 cm and the second system is configured to produce the second replicate at a size scalability larger than the first replicate produced by the first system.

47. The apparatus of claim 1, wherein the second system is configured to provide light exposure from the UV laser to be introduced layer-by layer simultaneously to allow layers to thoroughly solidify during printing.
